(19) United States
(12) Patent Application Publication
(10) Pub. No.: US 2003/0227860 A1
(43) Pub. Date: Dec. 11, 2003

(54) Diffraction element and optical pickup head device

(75) Inventors: Shinichi Hamaguchi, Amagasaki-shi (JP); Masahiko Nishimoto, Settsu-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO.,, Kadoma-shi (JP)

(21) Appl. No.: 10/455,464

(22) Filed: Jun. 4, 2003

(30) Foreign Application Priority Data
Jun. 7, 2002 (JP) 2002-167815

(51) Int. Cl. G11B 7/135

(52) U.S. Cl. 369/112.12

(57) ABSTRACT

It is an object of the invention to provide a diffraction element having a simple configuration for detecting light beams of different wavelengths that are irradiated in order to store or reproduce information with respect to different types of optical disks, and an optical pickup head device. The diffraction element includes a first diffraction grating for diffracting a first light beam having a first wavelength λ1 so as to emit a first first-order diffracted light beam, and a second diffraction grating for diffracting a second light beam having a second wavelength λ2, which is different from the first wavelength λ1, so as to emit a second first-order diffracted light beam. The first diffraction grating and the second diffraction grating are arranged so that the first first-order diffracted light beam diffracted by the first diffraction grating and the second first-order diffracted light beam diffracted by the second diffraction grating are focused onto a same photodetector.

### BACKGROUND OF THE INVENTION

1. Field of the Invention

The present invention relates to optical pickup head devices for recording, reproducing, or erasing information on optical media and magneto-optic media such as optical disks and optical cards, and to diffraction elements provided thereon.

2. Description of the Related Art

Optical memory technologies in which optical disks having pit-shaped patterns are used as high-density, large-capacity storage media are finding increasing application for digital audio disks, video disks, document file disks, and data files, among others. With these optical memory technologies, information is very precisely and reliably stored on and reproduced from optical disks through a tiny focused light beam. These operations for storage and reproduction depend entirely on the optical system.

The primary functions of an optical pickup head device, which is the principal element of the optical system, can be broadly divided into a focusing function for forming a tiny spot at the diffraction limit, a focal point control function and a tracking control function of the optical system, and a pit signal detection function. These functions are achieved by combining various optical systems and photoelectric conversion and detection techniques, depending on the purpose and the application of the device. In recent years in particular, optical pickup head devices have been disclosed that are provided with diffraction elements in order to make the optical pickup head more compact and thinner.

Hereinafter, an optical pickup head device provided with a diffraction element is described. FIG. 6 is a simplified cross-sectional view for describing a conventional optical pickup head device 80, and FIG. 7 is a cross-sectional view that schematically shows a conventional diffraction element 90 provided in the optical pickup head device 80. The optical pickup head device 80 is provided with a semiconductor laser 11 as a radiation source. The semiconductor laser 11 is supported substantially in the center of a plate-shaped support member 93. The support member 93 is provided with a photodetector 96 in a concentric circle with the semiconductor laser 11 at its center, and is also provided with a photodetector 95 outside the photodetector 96 in a concentric circle with the semiconductor laser 11 at its center. The semiconductor laser 11 for example emits either a light beam having a wavelength λ1 or a light beam having a wavelength λ2, which is shorter than the wavelength λ1, toward the diffraction element 90 in correspondence with the type of an optical disk 14.

The light beam that is emitted from the semiconductor laser 11 passes through the diffraction element 90, which has a diffraction grating 91 with a grating pitch d and a support member 98 for supporting the diffraction grating 91. The light beam that has passed through the diffraction element 90 is focused by a collimating lens 15 provided in a light focusing system 12 and is incident on an objective lens 16 provided in the light focusing system 12. The light beam incident on the objective lens 16 is focused on the optical disk 14, which is an information medium, by the objective lens 16 and is reflected by the optical disk 14.

The light beam reflected by the optical disk 14 travels in the opposite direction down its original path and is incident on the diffraction element 90. The light beam incident on the diffraction element 90 is diffracted into a first-order diffracted light beam by the diffraction grating 91 provided in the diffraction element 90, and is incident on either the photodetector 95 or the photodetector 96 in correspondence with the wavelength of the light beam. The photodetector 95 and the photodetector 96 detect the first-order diffracted light beam that is incident, and convert the detected first-order diffracted light beam into electrical signals for obtaining servo signals and information signals.

The conventional optical pickup head device 80 described above has the following problem, however. FIG. 8 is a cross-sectional view that schematically illustrates the first-order diffracted light beams that are diffracted by the conventional diffraction element 90.

When a light beam 6 having a wavelength λ1 is incident on the diffraction element 90 in a direction perpendicular to the diffraction element 90, it is diffracted by the diffraction grating 91 provided in the diffraction element 90 and emitted as a first-order diffracted light beam 2 in a direction forming an angle θ1 with respect to its direction of incidence. When a light beam 7 having a wavelength λ2, which is shorter than the wavelength λ1 of the light beam 6, is incident on the diffraction element 90 in a direction perpendicular to the diffraction element 90, it is diffracted by the diffraction grating 91 and emitted as a first-order diffracted light beam 4 in a direction forming an angle θ2, which is smaller than the angle θ1, with respect to its direction of incidence. When a light beam 18 having the wavelength λ3, which is shorter than the wavelength λ2 of the light beam 7, is incident on the diffraction element 90, it is diffracted by the diffraction grating 91 and emitted as a first-order diffracted light beam 19 in a direction forming an angle θ3, which is smaller than the angle θ2, with respect to its direction of incidence.

The angle θ1 at which the light beam 6 having the wavelength λ1 is diffracted by the diffraction element 90 and emitted satisfies the equation

d×sin θ1=n×λ1,

the angle λ2 at which the light beam 7 having the wavelength λ2 is diffracted by the diffraction element 90 and emitted satisfies the equation

d×sin θ2=n×λ2,

and the angle θ3 at which the light beam 18 having the wavelength λ3 is diffracted by the diffraction element 90 and emitted satisfies the equation

d×sin θ3=n×λ3.

Thus, the angle θ1 at which the light beam 6 having the wavelength λ1 is diffracted by the diffraction element 90 and emitted is larger than the angle θ2 at which the light beam 7 having the wavelength λ2 is diffracted by the diffraction element 90 and emitted, and the angle θ3 at which the light beam 18 having the wavelength λ3 is diffracted by the diffraction element 90 and emitted is smaller than the angle θ2, so that angle θ1, angle θ2, and angle θ3 are different from one another.

Consequently, a distance X11, which, due to the light beam 6 of the wavelength λ1 being diffracted by the diffraction element 90, is the distance in the direction perpendicular to the direction of incidence from a point removed by a distance H from the diffraction element 90 in the direction of incidence, is longer than a distance X12, which, due to the light beam 7 of the wavelength λ2 being diffracted by the diffraction element 90, is the distance in the direction perpendicular to the direction of incidence from a point removed by a distance H from the diffraction element 90 in the direction of incidence, and a distance X13, which, due to the light beam 18 of the wavelength λ3 being diffracted by the diffraction element 90, is the distance in the direction perpendicular to the direction of incidence by a distance H from a point removed from the diffraction element 90 in the direction of incidence, is shorter than the distance X12. Thus, the distance X11, the distance X12, and the distance X13 are different from one another.

For this reason, if, for example, the light beam 6, which has the wavelength λ1, is used for storing or reproducing information with respect to one type of optical disk and the light beam 7, which has the wavelength λ2, which is shorter than the wavelength λ1, is used for storing or reproducing information with respect to another type of optical disk, then when the light beam 6, which has the wavelength λ1, is emitted by the semiconductor laser 11, the light beam 6 of the wavelength λ1 is reflected by the one type of optical disk and diffracted by the diffraction grating 91 provided in the diffraction element 90, emitted in the direction dictated by the angle θ1, and is incident on the photodetector 95. When the light beam 7 having the wavelength λ2, which is shorter than the wavelength λ1, is emitted by the semiconductor 11, the light beam 7 of the wavelength λ2 is reflected by the other type of optical disk and diffracted by the diffraction grating 91 provided in the diffraction element 90, emitted in the direction dictated by the angle θ2, which is smaller than the angle θ1, and is incident on the photodetector 96.

Consequently, if light beams of different wavelengths are irradiated in order to store or reproduce information with respect to different types of optical disks, then there is the problem that dedicated photodetectors must be provided for each of the light beams having different wavelengths.

The present invention was arrived at in order to solve this problem, and it is an object thereof to provide a diffraction element with a simple configuration for detecting light beams of different wavelengths that are irradiated in order to store or reproduce information with respect to different types of optical disks, and an optical pickup head device.

### SUMMARY OF THE INVENTION

In order to achieve the object mentioned above, a diffraction element according to the present invention is characterized in that it includes a first diffraction grating for diffracting a first light beam having a first wavelength λ1 so as to emit a first first-order diffracted light beam, and a second diffraction grating for diffracting a second light beam having a second wavelength λ2, which is different from the first wavelength λ1, so as to emit a second first-order diffracted light beam, where the first diffraction grating and the second diffraction grating are arranged so that the first first-order diffracted light beam diffracted by the first diffraction grating and the second first-order diffracted light beam diffracted by the second diffraction grating are focused onto the same photodetector.

An optical pickup head device according to the present invention is characterized in that it includes a radiation source for irradiating a first light beam having a first wavelength λ1 and a second light beam having a second wavelength λ2, which is different from the first wavelength λ1, and a light focusing means for focusing the first light beam and the second light beam irradiated from the radiation source onto an information medium. A diffraction element is provided for diffracting the first and the second light beams reflected by the information medium and emitting first and second diffracted light beams, and a photodetector is provided for detecting the first and the second diffracted light beams and converting the detected first and second diffracted light beams into electrical signals. The diffraction element includes a first diffraction grating for diffracting the first light beam having the first wavelength λ1 so as to emit the first diffracted light beam and a second diffraction grating for diffracting the second light beam having the second wavelength λ2, which is different from the first wavelength λ1, so as to emit the second diffracted light beam, and the first diffraction grating and the second diffraction grating are arranged so that the first diffracted light beam diffracted by the first diffraction grating and the second diffracted light beam diffracted by the second diffraction grating are focused onto a same location of the photodetector.

Here, a diffraction grating refers to an optical element made of an assembly of narrow slits or grooves for diffracting and emitting numerous light beams that can interfere with one another from the slits or grooves, concentrating energy in different directions in correspondence with the wavelength.

### BRIEF DESCRIPTION OF THE DRAWINGS

FIG. 1 is a cross-sectional diagram schematically showing the optical pickup head device according to the embodiment.

FIG. 2A is a cross-sectional diagram for schematically illustrating the first-order diffracted light beam that is diffracted by the diffraction element provided in the optical pickup head device according to the embodiment.

FIG. 2B is a plain view showing another structure of support members.

FIG. 2C is a plain view showing another structure of photodetectors and a semiconductor laser.

FIG. 3 is a cross-sectional diagram for schematically illustrating the first-order diffracted light beam that is diffracted by another diffraction element according to the embodiment.

FIG. 4 is a cross-sectional diagram for schematically illustrating yet another diffraction element according to the embodiment.

FIG. 5 is a cross-sectional diagram for schematically illustrating yet another diffraction element according to the embodiment.

FIG. 6 is a cross-sectional diagram schematically showing a conventional optical pickup head device.

FIG. 7 is a cross-sectional diagram schematically showing a conventional diffraction grating.

FIG. 8 is a cross-sectional diagram for schematically illustrating the first-order diffracted light beam diffracted by the conventional diffraction element.

### DESCRIPTION OF THE PREFERRED EMBODIMENTS

In the diffraction element according to the invention, a first first-order diffracted light beam that is diffracted by a first diffraction grating and a second first-order diffracted light beam that is diffracted by a second diffraction element are focused onto the same photodetector. Thus, a first light beam having a first wavelength λ1 and a second light beam having a second wavelength λ2 can be detected by the same photodetector.

It is preferable that either the first light beam or the second light beam is incident on the diffraction element. Thus, mutually different first-order diffracted light beams from light beams of different wavelengths, which correspond to different information media, can be detected by the same photodetector.

It is preferable that the first diffraction grating has a grating pitch d that is identical to a grating pitch d of the second diffraction grating. This is because if the first and the second diffraction gratings have and identical grating pitch, then they can be produced easily.

It is preferable that the first wavelength λ1 of the first beam is longer than the second wavelength λ2 of the second beam, that a direction of incidence in which the first light beam is incident on the first diffraction grating and a direction of incidence in which the second light beam is incident on the second diffraction grating are identical, and that a first distance H1 from the first diffraction grating to the photodetector along the direction of incidence is longer than a second distance H2 from the first diffraction grating to the photodetector along the direction of incidence. This is because with this simple configuration it is possible to focus the first and the second light beams, which have different wavelengths, onto the same photodetector.

It is preferable that the diffraction element further includes a first support portion for supporting the first diffraction grating, and a second support portion for supporting the second diffraction grating, and that a step is formed in the direction of incidence between the first support portion and the second support portion. The second support portion may be provided in such a manner that it surrounds the first support portion, or the first support portion may be provided in such a manner that it surrounds the second support portion. Also, the second support portion may be provided in such a manner that it sandwiches the first support portion, or the first support portion may be provided in such a manner that it sandwiches the second support portion. Thus, the first diffraction grating and the second diffraction grating can be supported using a simple configuration.

It is preferable that the first diffraction grating has a grating pitch d that is identical to a grating pitch d of the second diffraction grating, and that the first distance H1 and the second distance H2 substantially satisfy the relationship

H1−H2=(X1×(d²−λ1²)^{1/2}/λ1)−(λ2×(d²−λ2²)^{1/2}/λ2)

wherein X1 is the distance from the first diffraction grating to the photodetector in a direction perpendicular to the direction of incidence, and X2 is the distance from the second diffraction grating to the photodetector in a direction perpendicular to the direction of incidence. Thus, the arrangement of the first and the second diffraction gratings and the photodetector can be determined easily.

It is preferable that the first diffraction grating and the second diffraction grating are arranged so that the first first-order diffracted light beam and the second first-order diffracted light beam are focused onto substantially a same location on the photodetector. Thus, the photodetector for detecting the first first-order diffracted light beam and the second first-order diffracted light beam can be made compact.

In an optical pickup head device according to the invention, a first diffracted light beam diffracted by a first diffraction grating and a second diffracted light beam diffracted by a second diffraction grating provided in a diffraction element are focused onto the same spot on a photodetector. Thus, light beams of different wavelengths that are reflected from different information media can be detected by the same photodetector, and moreover the photodetector can be made compact.

It is preferable that the radiation source irradiates either the first light beam or the second light beam in correspondence with the type of the information medium. This is because first-order diffracted light beams from a plurality of types of information media can be detected by the same photodetector.

It is preferable that the diffraction element is positioned between the radiation source and the light focusing means. It is preferable that the photodetector and the radiation source are positioned on the same plane. It is preferable that the photodetector and the radiation source are formed as a single unit. It is preferable that the photodetector is arranged so that it surrounds the radiation source. Also, it is preferable that the photodetector is arranged so that it sandwiches the radiation source. Thus, the optical pickup head device can be made compact.

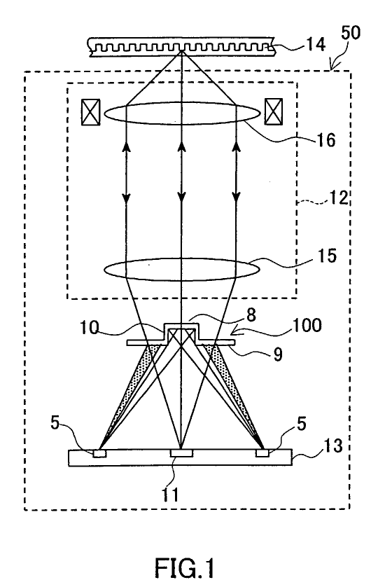

Hereinafter, an embodiment of the present invention is described with reference to the drawings. FIG. 1 is a cross-sectional view that schematically shows an optical pickup head device 50 according to this embodiment. The optical pickup head device 50 is provided with a semiconductor laser 11 as a radiation source. The semiconductor laser 11 is supported substantially in the center of a plate-shaped support member 13. The support member 13 is provided with a single photodetector 5 in a concentric circle with the semiconductor laser 11 at its center. The semiconductor laser 11 for example emits either a light beam having a wavelength λ1 or a light beam having a wavelength λ2, which is shorter than the wavelength λ1, toward a diffraction element 100, depending on the type of an optical disk 14.

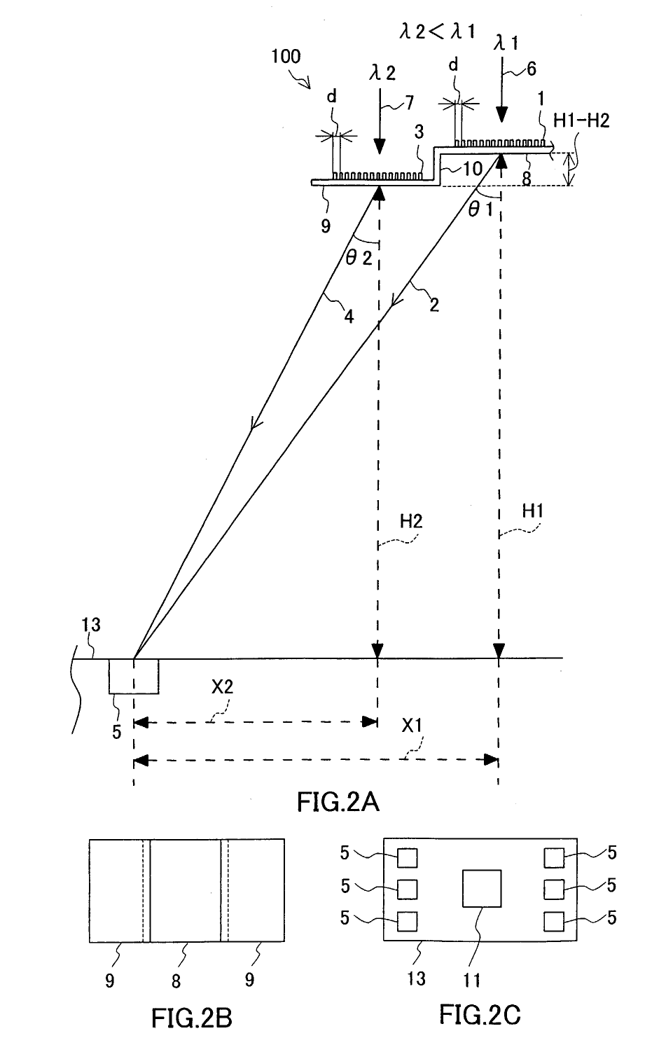

FIG. 2A is a cross-sectional diagram for schematically illustrating the diffraction element 100 provided in the optical pickup head device 50 according to this embodiment. The diffraction element 100 is provided with a substantially disk-shaped support member 8 opposing the semiconductor laser 11. A diffraction grating 1 having a grating pitch d is supported on the collimating lens 15 side surface of the support member 8. A step member 10 having a substantially cylindrical shape is formed at the periphery of the support member 8 in its photodetector 5 side surface and projects toward the photodetector 5. A support member 9 substantially having a the shape of a disk with an empty center is formed in the photodetector 5 side of the step member 10, and projects outward of the step member 8. A diffraction grating 3 having a grating pitch d is supported on the support member 9 on its surface on the collimating lens 15 side.

The light beam emitted from the semiconductor laser 11 passes through the diffraction element 100. The light beam that has passed through the diffraction element 100 is focused by the collimating lens 15 provided in the light focusing system 12 and is incident on the objective lens 16 provided in the light focusing system 12. The light beam incident on the objective lens 16 is focused on the optical disk 14, which is an information medium, by the objective lens 16 and is reflected by the optical disk 14. The light beam reflected by the optical disk 14 travels down its original path in the opposite direction and is incident on the diffraction element 100.

When the light beam 6 having the wavelength λ1 is incident on the diffraction grating 1, which is provided in the diffraction element 100, in a direction perpendicular to the support member 8, then the incident light beam 6 is diffracted by the diffraction grating 1 and is emitted as a first-order diffracted light beam 2 in the direction of an angle θ1 formed with respect to the direction of incidence. The angle θ1 at which the light beam 6 of the wavelength λ1 is diffracted by the diffraction grating 1 and emitted satisfies the equation

d×sin θ1=n×λ1.

When the light beam 7 having the wavelength λ2, which is shorter than the wavelength λ1 of the light beam 6, is incident on the diffraction grating 3 in a direction perpendicular to the support member 9, then the incident light beam 7 is diffracted by the diffraction grating 3 and is emitted as a first-order diffracted light beam 4 in the direction of an angle θ2, which is smaller than the angle θ1, formed with respect to the direction of incidence.

The angle θ2 at which the light beam 7 of the wavelength λ2 is diffracted by the diffraction element 100 and emitted satisfies the equation

d×sin θ2=n×λ2.

When the support member 8 and the support member 9 for supporting the diffraction grating 1 and the diffraction grating 3, respectively, and the step member 10, which forms the step between the support member 8 and the support member 9, are configured so as to satisfy the following equation, then the first-order diffracted light beam 2 that has been diffracted by the diffraction grating 1 and the first-order diffracted light beam 4 that has been diffracted by the diffraction grating 3 can be focused onto substantially the same spot on the same photodetector 5.

H1−H2=(X1×(d²−λ1²)^{1/2}/λ1)−(X2×(d²−λ2²)^{1/2}/λ2)

where

X1: distance from the diffraction grating 1 to the photodetector 5 in the direction perpendicular to the direction of incidence

X2: distance from the diffraction grating 3 to the photodetector 5 in the direction perpendicular to the direction of incidence

d: grating pitch of the diffraction grating 1 and the diffraction grating 3

λ1: wavelength of the light beam 6

λ2: wavelength of the light beam 7

Thus, the diffraction grating 1 and the diffraction grating 3 are arranged so that the first-order diffracted light beam 2 that is diffracted by the diffraction grating 1 and the first-order diffracted light beam 4 that is diffracted by the diffraction grating 3 are focused onto substantially the same spot on the same photodetector 5.

Thus, if, for example, the light beam 6, which has the wavelength λ1, is used for storing or reproducing information with respect to one type of optical disk and the light beam 7, which has the wavelength λ2, which is shorter than the wavelength λ1, is used for storing or reproducing information with respect to another type of optical disk, then when the light beam 6, which has the wavelength λ1, is emitted by the semiconductor laser 11, the light beam 6 of the wavelength λ1 is reflected by the one type of optical disk and diffracted by the diffraction grating 1 provided in the diffraction element 100, emitted in the direction dictated by the angle θ1, and is incident on the photodetector 5. When the light beam 7 having the wavelength λ2, which is shorter than the wavelength λ1, is emitted by the semiconductor 11, the light beam 7 of the wavelength λ2 is reflected by the other type of optical disk and diffracted by the diffraction grating 3 provided in the diffraction element 100, emitted in the direction dictated by the angle θ2, which is smaller than the angle θ1, and is incident on the photodetector 5, which is the same photodetector as that on which the first diffracted light beam 2 of the light beam 6, which has the wavelength λ1, is incident.

The photodetector 5 detects the first-order diffracted light beam that is incident and converts the detected first-order diffracted light beam into electric signals for obtaining servo signals and information signals.

As set forth above, according to this embodiment, the diffraction grating 1 and the diffraction grating 3 are arranged so that the first-order diffracted light beam 2 that is diffracted by the diffraction grating 1 and the first-order diffracted light beam 4 that is diffracted by the diffraction grating 3 are focused onto the same photodetector 5. Thus, light beams with different wavelengths that have been reflected from different information media can be detected by the same photodetector. As a result, it is possible to provide a diffraction element with a simple configuration for detecting light beams of different wavelengths that are irradiated in order to store or reproduce information with respect to different types of optical disks, and an optical pickup head device.

It should be noted that in the example shown, the support member 9, which has the substantially shape of a disk with an empty center, surrounds the support member 8 and the photodetector 5 surrounds the semiconductor laser 11, however, the present invention is not limited to this configuration. It is also possible to arrange a plurality of support members 9 so that they sandwich the support member 8 as shown in FIG. 2B, and arrange a plurality of photodetectors 5 so that they sandwich the semiconductor laser 11, as shown in FIG. 2C. Additionally, it is also possible to arrange the photodetector 5 on only one side of the semiconductor laser 11. Furthermore, there was only a single semiconductor laser 11 in the example, however, it is also possible to dispose two or more semiconductor lasers side by side.

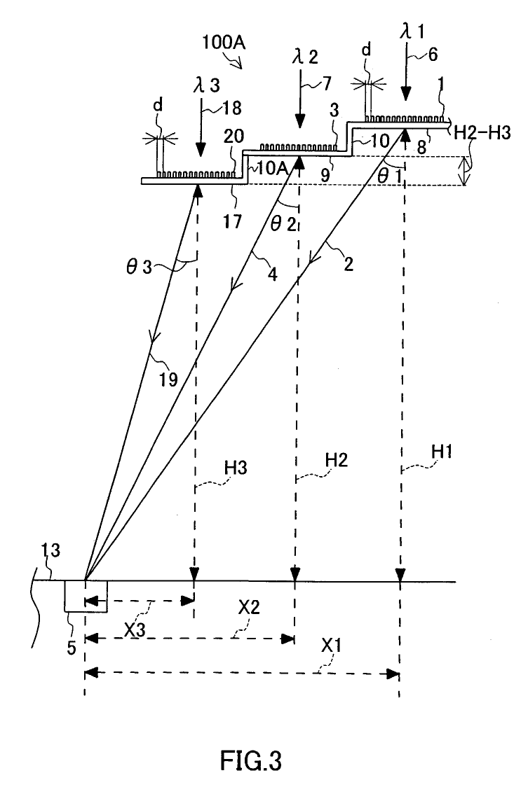

FIG. 3 is a cross-sectional view that schematically illustrates the first-order diffracted light beam that is diffracted by another diffraction element 100A according to this embodiment. Structural elements that are the same as the structural elements of the above-described diffraction grating 100 are assigned reference numbers identical to those in FIGS. 1 and 2. Consequently, a detailed description of these structural elements is omitted. The diffraction element 100A differs from the above-described diffraction element 100 in that it is further provided with a diffraction grating 20, a support member 17, and a step member 10A.

As shown in FIG. 3, in the diffraction grating 100A, the step member 10A, which is substantially cylindrical, is formed at the periphery of the support member 9, which substantially has the shape of a disk with an empty center, on the photodetector 5 side surface of the support member 9 in such a fashion that it projects outward toward the photodetector 5. The support member 17, which substantially has the shape of a disk with an empty center, is formed in the photodetector 5 side of the step member 10A in such a fashion that it projects outward of the step member 10A. The diffraction grating 20, which has the grating pitch d, is supported in the surface of the support member 17 on its collimating lens 15 side.

When the light beam 18 having the wavelength λ3, which is shorter than even the wavelength λ2 of the light beam 7, is incident on the diffraction element 100A in the direction perpendicular to the support member 17, the incident light beam 18 is diffracted by the diffraction grating 20 and emitted as the first-order diffracted light beam 19 in the direction formed by the angle θ3, which is smaller than even the angle θ2, with respect to the direction of incidence.

The angle θ3 at which the light beam 18 having the wavelength λ3 is diffracted by the diffraction grating 20 and emitted satisfies the equation

d×sin θ3=n×X3.

When the support member 9 and the support member 17 for supporting the diffraction grating 3 and the diffraction grating 20, respectively, and the step member 10A, which forms the step between the support member 9 and the support member 17, are configured so as to satisfy the following equation, then the first-order diffracted light beam 4 that is diffracted by the diffraction grating 3 and the first-order diffracted light beam 19 that is diffracted by the diffraction grating 20 can be focused onto substantially the same spot on the same photodetector 5.

H2−H3=(X2×(d²−λ2²)^{1/2}/λ2)−(X3×(d²λ3²)^{1/2}/λ3)

where

X2: distance from the diffraction grating 3 to the photodetector 5 in the direction perpendicular to the direction of incidence

X3: distance from the diffraction grating 20 to the photodetector 5 in the direction perpendicular to the direction of incidence

d: grating pitch of the diffraction grating 3 and the diffraction grating 20

λ2: wavelength of the light beam 7

λ3: wavelength of the light beam 18

Thus, there can be two rather than one step member provided in the diffraction element. When two step members are provided, it is possible to provide three types of diffraction gratings for focusing light beams of three wavelengths corresponding to three types of optical disks onto the same photodetector.

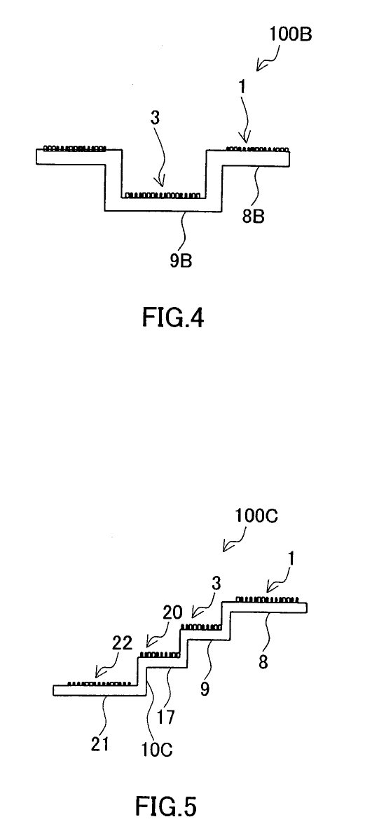

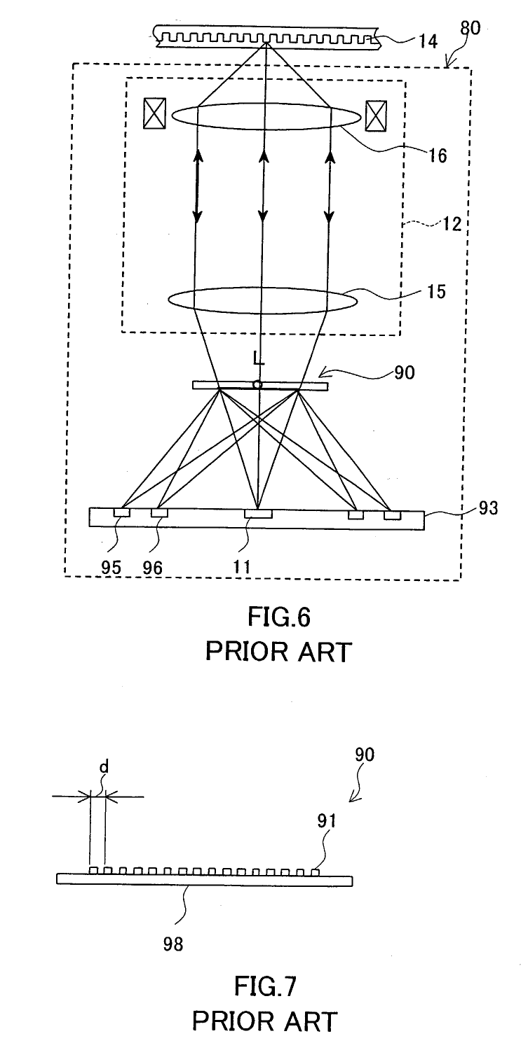

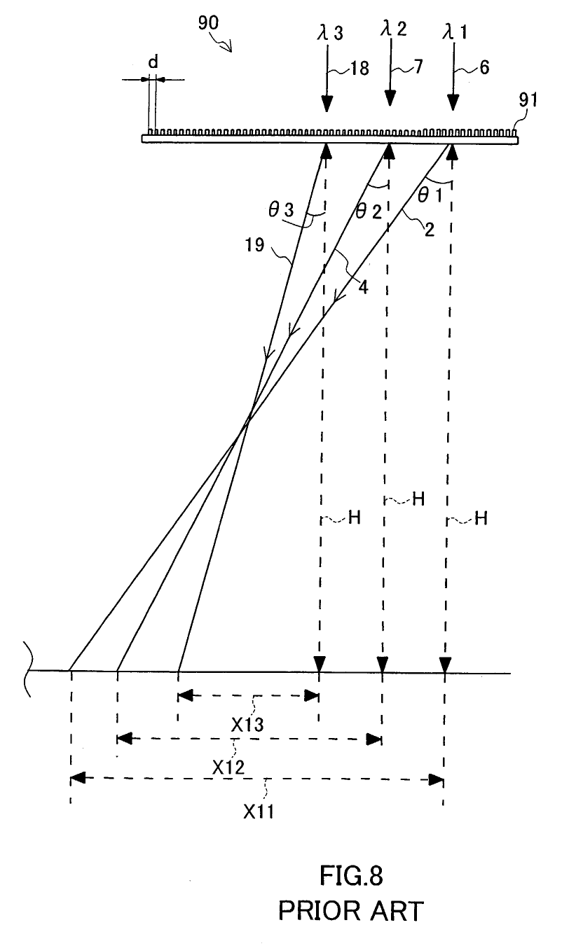

FIG. 4 is a cross-sectional view that schematically illustrates yet another diffraction element 100B according to this embodiment. Structural elements that are the same as the structural elements of the above-described diffraction grating 100 are assigned reference numbers identical to those in FIGS. 1 and 2. Consequently, a detailed description of these structural elements is omitted. The diffraction element 100 described above was configured in such a fashion that a projection was formed toward the collimating lens 15 so that the support member 8 for supporting the diffraction grating 1 was surrounded by the support member 9 for supporting the diffraction grating 3. However, conversely, the same action and effects as those described above can be achieved through a configuration in which a recession when viewed from the collimating lens 15 is formed so that a support member 9B for supporting the diffraction grating 3 is surrounded by a support member 8B for supporting the diffraction grating 1.

FIG. 5 is a cross-sectional view that schematically illustrates yet another diffraction element 100C according to this embodiment. Structural elements that are the same as the structural elements of the above-described diffraction grating 100A are assigned reference numbers identical to those in FIG. 3. Consequently, a detailed description of those structural elements is omitted. The diffraction element 100C differs from the above-described diffraction element 100A in that it is further provided with a diffraction grating 22, a support member 21, and a step member 10C.

In the diffraction grating 100C, the step member 10C, which is substantially cylindrical in shape, is formed at the periphery of the surface of the support member 17, which substantially has the shape of a disk with an empty center, on the photodetector 5 side in such a fashion that it projects outward toward the photodetector 5. The support member 21, which substantially has the shape of a disk with an empty center, is formed in the photodetector 5 side of the step member 10C in such a fashion that it projects outward of the step member 10A. The diffraction grating 22, which has the grating pitch d, is supported in the surface of the support member 21 on the collimating lens 15 side. Thus, there can be three steps provided in the diffraction element, and there also can be four or more steps provided in the diffraction element.

It should be noted that in this embodiment an example was shown in which the diffraction gratings were formed as flat plates. However, the present invention is not limited to this configuration. When the diffraction gratings are given curvature in order to generate a lens effect in the diffraction gratings, the first-order diffracted light beams can be focused onto even narrower regions on the photodetector 5. Thus, the area of the photodetector 5 onto which light is focused can be made even smaller, allowing the optical pickup head device to be made compact. Also, the detection sensitivity of the photodetector 5 can be increased.

Also, the diffraction element 100 was arranged between the semiconductor laser 11 and the collimating lens 15 in the example shown. However, it can also be arranged between the collimating lens 15 and the objective lens 16.

Furthermore, it is also possible to arrange a diffraction element for diffracting the light beams that are irradiated from the semiconductor laser 11 between the semiconductor laser 11 and the diffraction element 100.

An example was shown in which the photodetector 5 and the semiconductor laser 11 were provided as a single unit due to the support member 13. However, it is also possible to provide the photodetector 5 and the semiconductor laser 11 separate from one another.

Thus, with the present invention it is possible to provide a diffraction element with a simple configuration for detecting light beams of different wavelengths that are irradiated in order to store or reproduce information with respect to different types of optical disks, and an optical pickup head device.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A diffraction element comprising:
a first diffraction grating for diffracting a first light beam having a first wavelength λ1 so as to emit a first first-order diffracted light beam, and
a second diffraction grating for diffracting a second light beam having a second wavelength λ2, which is different from the first wavelength λ1, so as to emit a second first-order diffracted light beam;
wherein the first diffraction grating and the second diffraction grating are arranged so that the first first-order diffracted light beam diffracted by the first diffraction grating and the second first-order diffracted light beam diffracted by the second diffraction grating are focused onto the same photodetector.

2. The diffraction element according to claim 1,
wherein either the first light beam or the second light beam is incident on the diffraction element.

3. The diffraction element according to claim 1,
wherein the first diffraction grating has a grating pitch d that is identical to a grating pitch d of the second diffraction grating.

4. The diffraction element according to claim 1,
wherein the first wavelength λ1 of the first beam is longer than the second wavelength λ2 of the second beam;
wherein a direction of incidence in which the first light beam is incident on the first diffraction grating and a direction of incidence in which the second light beam is incident on the second diffraction grating are identical; and
wherein a first distance Hi from the first diffraction grating to the photodetector along the direction of incidence is longer than a second distance H2 from the second diffraction grating to the photodetector along the direction of incidence.

5. The diffraction element according to claim 4, further comprising:
a first support portion for supporting the first diffraction grating; and
a second support portion for supporting the second diffraction grating;
wherein a step is formed in the direction of incidence between the first support portion and the second support portion.

6. The diffraction element according to claim 5,
wherein the second support portion is provided in such a manner that it surrounds the first support portion.

7. The diffraction element according to claim 5,
wherein the first support portion is provided in such a manner that it surrounds the second support portion.

8. The diffraction element according to claim 5,
wherein the second support portion is provided in such a manner that it sandwiches the first support portion.

9. The diffraction element according to claim 5,
wherein the first support portion is provided in such a manner that it sandwiches the second support portion.

10. The diffraction element according to claim 4,
wherein the first diffraction grating has a grating pitch d that is identical to a grating pitch d of the second diffraction grating; and
wherein the first distance H1 and the second distance H2 substantially satisfy the relationship
H1−H2=(X1×(d²−λ1²)^{1/2}/λ1)−(X2×(d²−λ2²)^{1/2}/λ2)
wherein,
X1 is the distance from the first diffraction grating to the photodetector in a direction perpendicular to the direction of incidence, and
X2 is the distance from the second diffraction grating to the photodetector in a direction perpendicular to the direction of incidence.

11. The diffraction element according to claim 1,
wherein the first diffraction grating and the second diffraction grating are arranged so that the first first-order diffracted light beam and the second first-order diffracted light beam are focused onto substantially a same location on the photodetector.

12. An optical pickup head device comprising:
a radiation source for irradiating a first light beam having a first wavelength λ1 and a second light beam having a second wavelength λ2, which is different from the first wavelength λ1;
a light focusing element for focusing the first light beam and the second light beam irradiated from the radiation source onto an information medium;
a diffraction element for diffracting the first and the second light beams reflected by the information medium so as to emit first and second diffracted light beams; and
a photodetector for detecting the first and the second diffracted light beams and converting the detected first and second diffracted light beams into electrical signals;
wherein the diffraction element comprises:
a first diffraction grating for diffracting the first light beam having the first wavelength λ1 so as to emit the first diffracted light beam, and a second diffraction grating for diffracting the second light beam having the second wavelength λ2, which is different from the first wavelength λ1, so as to emit the second diffracted light beam; and
wherein the first diffraction grating and the second diffraction grating are arranged so that the first diffracted light beam diffracted by the first diffraction grating and the second diffracted light beam diffracted by the second diffraction grating are focused onto substantially the same location of the photodetector.

13. The optical pickup head device according to claim 12,
wherein the radiation source irradiates either the first light beam or the second light beam in correspondence with a type of the information medium.

14. The optical pickup head device according to claim 12,
wherein the diffraction element is arranged between the radiation source and the light focusing element.

15. The optical pickup head device according to claim 12,
wherein the photodetector and the radiation source are arranged on the same plane.

16. The optical pickup head device according to claim 12,
wherein the photodetector and the radiation source are formed as a single unit.

17. The optical pickup head device according to claim 12,
wherein the photodetector is arranged so that it surrounds the radiation source.

18. The optical pickup head device according to claim 12,
wherein the photodetector is arranged so that it sandwiches the radiation source.

19. The optical pickup head device according to claim 12,
wherein the first wavelength λ1 of the first beam is longer than the second wavelength λ2 of the second beam;
wherein a direction of incidence in which the first light beam is incident on the first diffraction grating and a direction of incidence in which the second light beam is incident on the second diffraction grating are identical; and
wherein a first distance H1 from the first diffraction grating to the photodetector along the direction of incidence is longer than a second distance H2 from the second diffraction grating to the photodetector along the direction of incidence.
